(19) United States
(12) Patent Application Publication
(10) Pub. No.: US 2024/0284336 A1
(43) Pub. Date: Aug. 22, 2024

(54) WAVEFORM FOR SIDELINK WAKEUP SIGNAL

(71) Applicant: QUALCOMM Incorporated, San Diego, CA (US)

(72) Inventors: Luanxia YANG, Beijing (CN); Jing SUN, San Diego, CA (US); Changlong XU, Beijing (CN); Xiaoxia ZHANG, San Diego, CA (US)

(21) Appl. No.: 18/567,863

(22) PCT Filed: Aug. 14, 2021
(86) PCT No.: PCT/CN2021/112638

§ 371 Date: Dec. 7, 2023

(51) Int. Cl. H04W 52/02; H04W 72/25; H04W 76/28

(52) U.S. Cl. CPC H04W 52/0235; H04W 72/25; H04W 76/28

(57) ABSTRACT

Wireless communications systems and methods related to communicating control information are provided. A method of wireless communication performed by a first user equipment (UE) may include monitoring, during an offset before a discontinuous reception on (DRX ON) period, for a sequence in resource elements transmitted by a second UE, receiving, based on the monitoring for the sequence in resource elements, a wake-up signal (WUS) from the second UE, entering a DRX ON mode in response to receiving the wake-up signal, and receiving, from the second UE, a transport block via a physical sidelink shared channel (PSSCH).

### TECHNICAL FIELD

This application relates to wireless communication systems, and more particularly to methods and devices for wireless communication using physical sidelink shared channels for a wakeup signal.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a first user equipment (UE) may include monitoring, during an offset before a discontinuous reception on (DRX ON) period, for a sequence in resource elements transmitted by a second UE; receiving, based on the monitoring for the sequence in resource elements, a wake-up signal (WUS) from the second UE; entering a DRX ON mode in response to receiving the wake-up signal; and receiving, from the second UE, a transport block via a physical sidelink shared channel (PSSCH).

In an additional aspect of the disclosure, a method of wireless communication performed by a first user equipment (UE) may include monitoring, during an offset before a discontinuous reception on (DRX ON) period, for a physical sidelink control channel (PSCCH) signal; receiving, based on the monitoring for the PSCCH signal, a wake-up signal (WUS) from a second UE; and entering a DRX ON mode in response to receiving the wake-up signal.

In an additional aspect of the disclosure, a UE may include a transceiver, a memory, and a processor coupled to the transceiver and the memory, the UE may be configured to monitor, during an offset before a discontinuous reception on (DRX ON) period, for a sequence in resource elements transmitted by a second UE; receive, based on the monitoring for the sequence in resource elements, a wake-up signal (WUS) from the second UE; enter a DRX ON mode in response to receiving the wake-up signal; and receive, from the second UE, a transport block via a physical sidelink shared channel (PSSCH).

In an additional aspect of the disclosure, a UE may include a transceiver, a memory, and a processor coupled to the transceiver and the memory, the UE may be configured to monitor, during an offset before a discontinuous reception on (DRX ON) period, for a physical sidelink control channel (PSCCH) signal; receive, based on the monitoring for the PSCCH signal, a wake-up signal (WUS) from a second UE; and enter a DRX ON mode in response to receiving the wake-up signal.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates a discontinuous receive cycle associated with a wireless communication network according to some aspects of the present disclosure.

FIG. 3 illustrates a data structure associated with a group-based wakeup signal according to some aspects of the present disclosure.

FIG. 4 is a signaling diagram of a communication method according to some aspects of the present disclosure.

FIG. 5 is a signaling diagram of a communication method according to some aspects of the present disclosure.

FIG. 6 is a block diagram of an exemplary user equipment (UE) according to some aspects of the present disclosure.

FIG. 7 is a block diagram of an exemplary base station (BS) according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜IM nodes/km²), ultra-low complexity (e.g., ˜10 s of bits/see), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present application describes mechanisms for a UE to communicate a wakeup signal (WUS) to another UE via sidelink communications. The UE may use sidelink communications to wake up one or more UEs such that each UE or each group of UEs may be woken up from a low power mode. The UE may use a sequence and/or a physical sidelink control channel (PSCCH) to wake up the UE or group of UEs. The UE or group of UEs may enter a DRX ON mode after being woken up. The UE or group of UEs may monitor for transport blocks during the DRX ON mode. The UE or group of UEs may receive one or more transport blocks during the DRX ON mode.

In some aspects of the present disclosure, the power consumption of a UE may be reduced by waking up a UE when a transport block is scheduled to be transmitted to the UE and allowing the UE to remain in a low power mode when there are no TBs scheduled to be transmitted to the UE as compared to the UE waking up at the beginning of each DRX ON cycle.

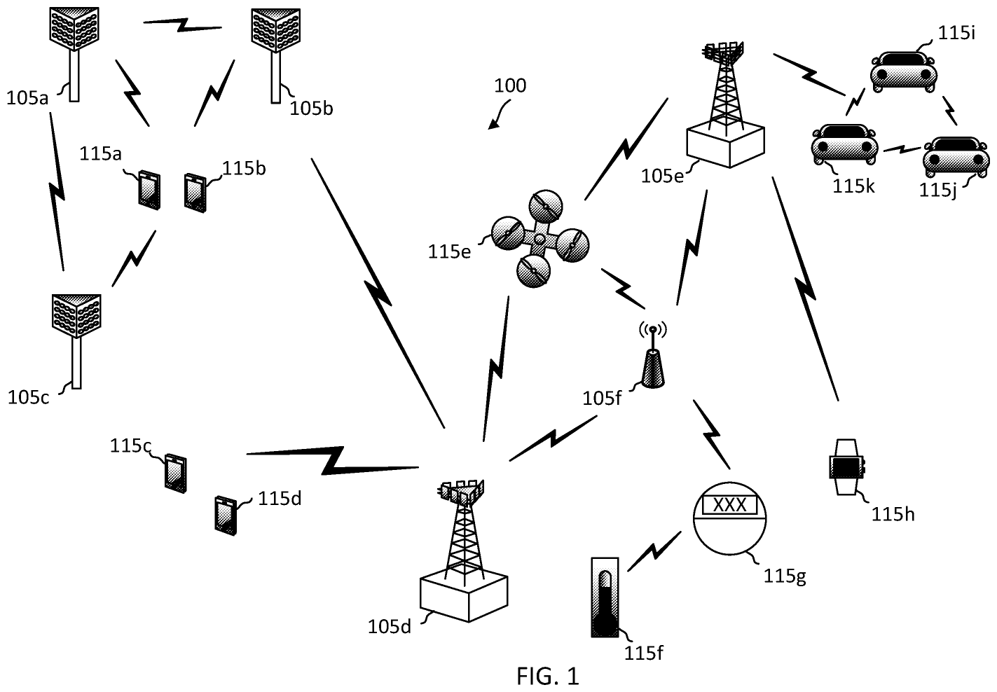

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115g (e.g., a meter, a programmable logic controller, an IoT device, a robot, a vehicle, a smartphone, etc.) may map a sub-PSCCH, a sub-PSSCH, sidelink control information (SCI), and an automatic gain control (AGC) symbol to a sub-slot of a plurality of sub-slots of a slot. In some aspects, the network (e.g., the network 100 or 200) may include a mix of both UEs that support the sub-slot structure (e.g., the sub-slot-based UEs 115) and legacy UEs that do not support the sub-slot structure, but support the slot structure (e.g., the slot-based UEs 115).

In the wireless communication network 100, DRX is a technique in which the UE 115 may enter a low power mode (e.g., a sleep mode, idle mode, or DRX off mode) for a certain period of time (e.g., DRX OFF duration or DRX OFF period) and enter a wake mode (e.g., an active mode, a monitoring mode, or DRX ON mode) for another period of time (e.g., DRX ON duration or DRX ON period). The UE 115 may be configured for DRX, including connected DRX, by the BS 105. When operating in a DRX mode, the UE 115 may enter an idle state for a DRX OFF period and wake up periodically to enter a DRX ON period to monitor for traffic. When configured for a DRX cycle, the UE 115 may wake up at the DRX ON scheduled time and stay awake for the entire duration of the DRX ON period. While the UE 115 operates in the DRX ON mode, the UE 115 may monitor for signals from another UE 115 that may indicate whether there is any data for the UE 115 to receive. The UE 115 may remain in the DRX ON mode for the entire duration of the DRX ON time period even if there is no data for the UE 115 to receive, which may cause the UE 115 to consume power unnecessarily. Aspects of the present disclosure may reduce power consumption in the UE 115 by sending a wakeup signal (WUS) to the UE 115 prior to the DRX ON period to indicate whether the UE 115 should enter the DRX ON mode. The WUS may be transmitted to the UE 115 only when there is data to be communicated to the UE 115 in the DRX ON period. Thus, aspects of the present disclosure can provide UE power savings by allowing the UE 115 to stay in a low power mode through a scheduled DRX ON period when there is no data to be communicated to the UE 115.

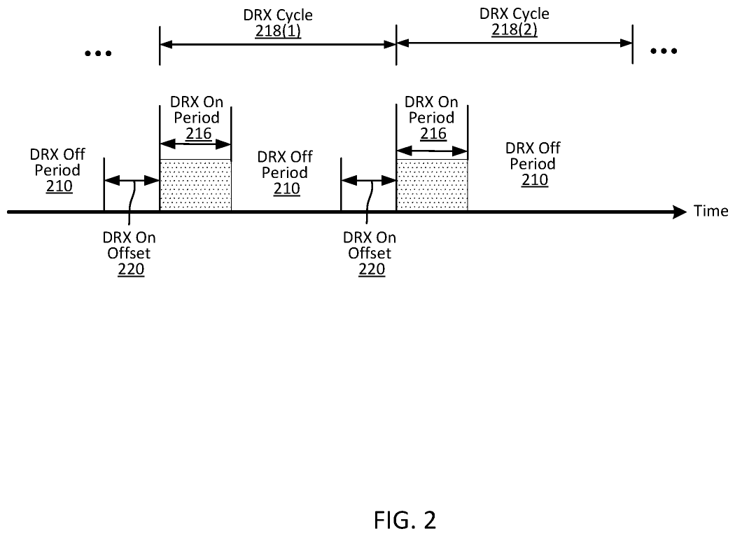

FIG. 2 illustrates a discontinuous receive (DRX) cycle 218 associated with a wireless communication network (e.g., network 100) according to some aspects of the present disclosure. In FIG. 2, the x-axis represents time in some arbitrary units. The DRX cycle 218 may include a DRX ON period 216 and a DRX OFF period 210. In the wireless communication network 100, DRX is a technique in which a UE (e.g., the UE 115 or the UE 600) may enter a DRX OFF mode (e.g., a low power mode, a sleep mode, an idle mode) for the DRX OFF period 210 and enter the DRX ON mode (e.g., a wake mode, an active mode, a monitoring mode) for a DRX ON period 216. The UE may be configured for DRX by a BS (e.g., the BS 105 or the BS 700). In some aspects, the UE may receive a WUS from another UE during a DRX ON offset 220 prior to the DRX ON period 216. The WUS may indicate whether the UE should enter the DRX ON mode during the DRX ON period 216. The WUS may be transmitted to the UE only when there is data to be transmitted to the UE. Aspects of the present disclosure may enable the UE to reduce power consumption by allowing the UE to stay in a low power mode through a scheduled DRX ON period 216 when there is no data to be transmitted to the UE. The DRX cycle 218 may be configured by the BS. In this regard, the BS may transmit the DRX cycle configuration to the UE in a RRC ConnectionReconfiguration message or a RRC Connection Setup message.

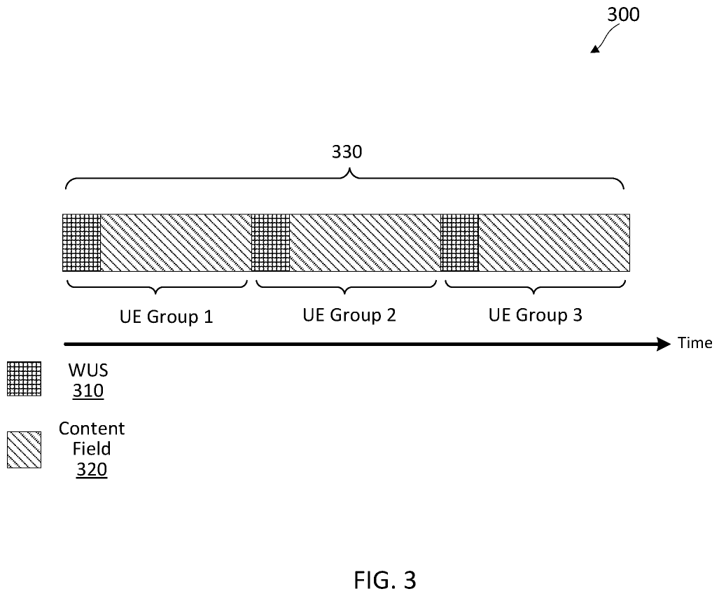

FIG. 3 illustrates a data structure 300 associated with a group-based wakeup signal 330 according to some aspects of the present disclosure. In FIG. 3, the x-axis represents time in some arbitrary units. The group-based wakeup signal 330 may include a wakeup signal (WUS) 310 for each group of UEs (e.g., UE group 1, UE group 2, UE group 3). A UE may transmit the group-based wakeup signal 330 to wake up different groups of UEs (e.g., UE group 1, UE group 2, UE group 3). In some aspects, a different UE may transmit a group based WUS 310 to each of the different groups of UEs (e.g., UE group 1, UE group 2, UE group 3). In this regard, the group-based WUS 330 may be transmitted in a PSCCH. The group-based wakeup signal 330 may include a content field 320 and a WUS 310 for each group of UEs. The group-based wakeup signal 330 may wake up different groups of UEs based on a group identifier for each group. The content field 320 may include the UE group identifier associated with the specific UE group. In some aspects, the UE group may include a single UE. The content field 320 may include the RP that each of the UEs in the UE group may use when the UE wakes up and enters the DRX ON mode based on receiving the WUS 310. The content field 320 may include a number of DRX cycles each of the UEs in the UE group may stay awake for after receiving the WUS 310.

In some aspects, the content field 320 may include the offset (e.g., DRX ON offset 220) from the DRX ON period (e.g., DRX ON period 216). The offset may be based on the group UE identifier indicated in content field 320. For example, UE group 1, UE group 2, and UE group 3 may each have a different offset from the DRX ON period in which the UEs in the group will monitor for the WUS. The offset may be indicated as a number of symbols, a number of sub-slots, and/or an amount of time (e.g., a number of microseconds, or milliseconds) before the beginning of the DRX ON mode. The offset may be based on the amount of time required for the UEs in the group to recognize a WUS sequence or decode the SCI-1.

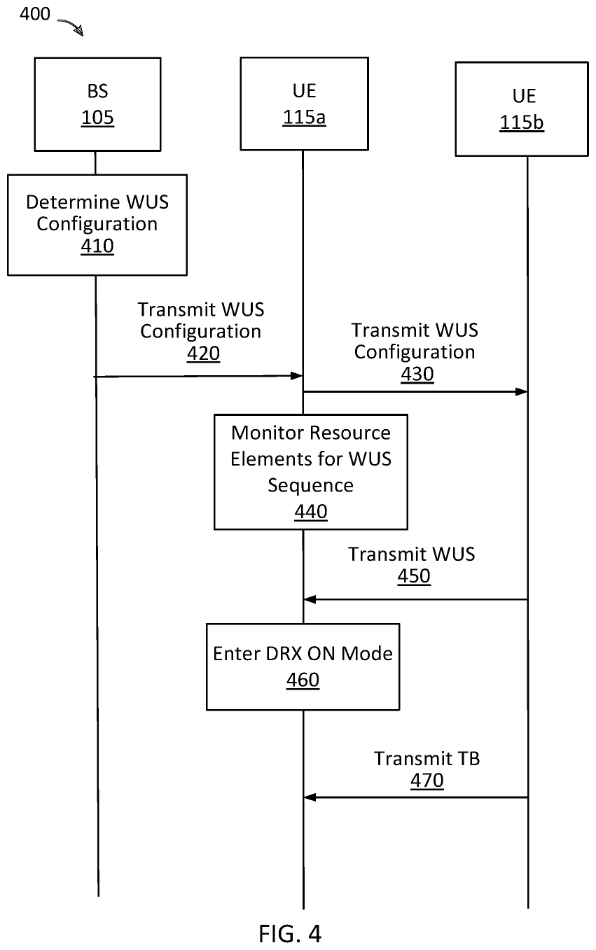

FIG. 4 is a signaling diagram of a communication method according to some aspects of the present disclosure. Aspects of the signaling diagram 400 can be executed by a computing device (e.g., a processor, processing circuit, and/or other suitable component) of a communication device or other suitable means for performing the aspects. For example, a communication device, such as the BS 105 or the BS 700, may utilize one or more components, such as a processor 702, a memory 704, instructions 706, a WUS detection module 708, a transceiver 710, a modem 712, an RF unit 714, and one or more antennas 716 to execute the aspects of signaling diagram 400. A wireless communication device, such as the UE 115 or UE 600, may utilize one or more components, such as the processor 602, the memory 604, the WUS detection module 608, the transceiver 610, the modem 612, and the one or more antennas 616, to execute the aspects of signaling diagram 400.

At 410, a BS 105 may determine a WUS configuration. The WUS configuration may include, without limitation, a location of the resource elements that carry a WUS sequence, an amount of the offset before the DRX ON period, and/or a type of the WUS sequence. In some aspects, the sequence may be transmitted in resource elements monitored by the UE. The resource elements may be indicated by the WUS configuration and include any suitable time/frequency resources the UE is capable of monitoring. The resource elements may be resources reserved for (e.g., dedicated to) the UE. The reserved resources may be specific to the UE and other resources may be reserved for other UEs such that specific UEs may be woken from a low power mode based on the sequence being transmitted in the reserved resources specific to that UE. For example, the resources may be time domain resources that include certain symbols, slots, or sub-slots reserved for the UE. The resources may be frequency domain resources that include a certain frequency, range of frequencies, subchannel, or subbands reserved for the UE.

At 420, the BS 105 may transmit the WUS configuration to the UE 115a. In this regard, the BS 105 may transmit the WUS configuration to the UE 115a via at least one of radio resource control (RRC) signaling, PDCCH signaling, or media access control (MAC) control element (CE) signaling. The WUS configuration may include a location of the resource elements that include the WUS sequence. For example, the WUS configuration may indicate the time resources (e.g., symbols, sub-slots, slots, subframes, etc.) in which the WUS sequence is located. The WUS configuration may indicate the frequency resources (e.g., a frequency, a range of frequencies, a subchannel(s), a BWP, a subframe(s), or a subband(s), etc.) in which the WUS sequence is located. The WUS configuration may indicate the resource elements are reserved for the WUS sequence.

In some aspects, the WUS configuration may indicate the time offset before the DRX ON period in which the UE will monitor for the WUS sequence. The time offset may include a time period or time duration before the beginning of the DRX ON period. The time offset may be indicated as a number of symbols, a number of sub-slots, and/or an amount of time (e.g., a number of microseconds, or milliseconds) before the beginning of the DRX ON mode. The offset may be based on the amount of time required for the UE to decode the WUS.

At 430, the UE 115a may transmit the WUS configuration to the UE 115b. The WUS may include the parameters required to wake up the UE 115a from a low power mode. The UE 115a may transmit the WUS configuration to the UE 115b so that the UE 115b may wake up the UE 115a when the UE 115b is scheduled to transmit a TB to the UE 115a.

At 440, the UE 115a may monitor resource elements for the WUS sequence. The UE 115a may monitor for a sequence in resource elements transmitted by the UE 115b during an offset before a DRX ON period. The sequence may include any suitable type of sequence. For example, the sequence may include a pseudo-random sequence having a constant amplitude. The sequence may include, without limitation, a Zadoff-Chu sequence, an m-sequence, a Gold sequence, a Kasami sequence, a Barker sequence, a pseudo-random sequence, and/or combinations thereof. In some aspects, the sequence may be a sequence that is specific to the UE 115a and/or a group of UEs that includes the UE 115a. The BS 105 may assign a different sequence to one or more of the UEs including the UE 115a such that each UE or each group of UEs may be individually woken up from a low power mode by the specific WUS sequence associated with the UE or group of UEs.

In some aspects, the sequence may include a scrambling code. The scrambling code may be any suitable type of scrambling code. A different scrambling code may be assigned to each UE. The UE 115a may monitor the sequence to detect the scrambling code. When the assigned scrambling code is detected in the sequence during the offset, the UE 115a may wake up from the low power mode and enter the DRX ON mode.

In some aspects, the UE may monitor a communication channel for a WUS that indicates the UE 115a should exit the low power mode. For example, the UE 115a may monitor for a WUS in a physical sidelink control channel (PSCCH), an SCI-1, a physical sidelink shared channel (PSSCH), a physical sidelink broadcast channel (PSBCH) communications, other types of sidelink communications, physical downlink control channel (PDCCH) communications, physical downlink shared channel (PDSCH) communications, and/or physical broadcast channel (PBCH) communications. The WUS may be a sequence indicating that there is data and/or control information to be communicated to the UE 115a. The UE 115a may place its receiver in a mode capable of monitoring for and/or receiving the data and/or control information in response to receiving the WUS.

In some aspects, the resources may be resources reserved for (e.g., dedicated to) a group of UEs that includes the UE 115a. The reserved resources may be specific to a group of UEs that includes the UE 115a and other resources may be reserved for other groups of UEs that do not include the UE 115a such that specific groups of UEs may be woken up from a low power mode based on the sequence being transmitted in the reserved resources specific to the UE group. For example, the resources may be time domain resources that include certain symbols, slots, or sub-slots reserved for the group of UEs. The resources may be frequency domain resources that include a certain frequency, range of frequencies, subchannel, BWP, or subbands reserved for the group of UEs.

The UE 115a may monitor the resources during an offset before the UE 115a is scheduled to enter the DRX ON mode. The offset may be a time period before the start of the DRX ON mode. The UE 115a may monitor the resources from the beginning of the offset time period to the end of the offset time period. The end of the offset time period may be the beginning of the DRX ON period. The time offset may be indicated as a number of symbols, a number of sub-slots, and/or an amount of time (e.g., a number of microseconds, or milliseconds) before the beginning of the DRX ON mode. The offset may be based on the amount of time required for the UE 115a to decode the WUS. In some aspects, the offset time period may occur before the DRX ON period but the DRX ON period may not immediately follow the offset time period. For example, there may be a time gap between the end of the offset period and the beginning of the DRX ON period.

At 450, the UE 115b may transmit the WUS to the UE 115a. The UE 115b may transmit a sequence to the UE 115a that the UE 115a recognizes as the WUS. In some instances, the UE 115b may transmit the WUS during the offset time period before the DRX ON period. In some aspects, the presence of the WUS may indicate to the UE 115a that there is a transport block (TB) and/or other communication scheduled for the UE 115a in the upcoming DRX ON period. If the UE 115a detects a WUS in the offset time period before the DRX ON period, then the UE 115 can enter the DRX ON mode and monitor for and/or receive the TB or other communication during the DRX ON period. If the UE 115a does not detect a WUS in the offset time period before the DRX ON period, then the UE 115a can immediately return to a low power mode or idle mode through the DRX ON period following the offset time period.

At 460, the UE 115a may enter the DRX ON mode. The UE 115a may enter the DRX ON mode in response to receiving the WUS at 450. The UE 115a may enter the DRX ON mode if the UE 115a receives the WUS during the offset period in which the UE 115a is monitoring for the WUS sequence. The UE 115a may not enter the DRX ON mode (e.g. refrain from entering the DRX ON mode) if the UE 115a does not receive the WUS during the offset period in which the UE 115a is monitoring for the WUS sequence. In some aspects, the UE 115a may power down a portion of its receiver to reduce power consumption when monitoring for the WUS sequence during the offset period. The UE 115a may have limited power source capacity and may benefit from operating in a low power mode when not communicating. The UE 115b may wake up the UE 115a from the low power mode by transmitting a WUS to the UE 115a and subsequently transmitting one or more TBs to the UE 115a.

If the UE 115a receives the WUS and enters the DRX ON mode, the UE 115a may power up the portion of its receiver that was powered down during the offset period and monitor for sidelink signals. In some aspects, the UE 115a may enter one or more DRX ON cycles based on receiving the WUS. When the UE 115a is operating in the DRX ON mode for a DRX ON duration, the UE 115a may monitor for sidelink communications from the UE 115b and/or transmit sidelink communications to other UEs. For example, when the UE 115a is operating in the DRX ON mode, the UE 115a may monitor for a physical sidelink control channel (PSCCH), a physical sidelink shared channel (PSSCH), a physical sidelink broadcast channel (PSBCH) communications, other types of sidelink communications, physical downlink control channel (PDCCH) communications, physical downlink shared channel (PDSCH) communications, and/or physical broadcast channel (PBCH) communications.

At 470, the UE 115b may transmit a TB to the UE 115a via a PSSCH. The UE 115a may receive the TB from the UE 115b based on monitoring for sidelink communications from the UE 115b during the DRX ON duration. The UE 115a may receive the TB in resources configured by a configured grant (CG). For example, the UE 115a may receive a CG from BS 105 and/or the UE 115b that configures time/frequency resource for the UE 115a to receive sidelink communications and/or transmit sidelink communications. In some aspects, the UE 115a may receive the TB in a PSSCH mapped to symbols within a slot. Additionally or alternatively, the UE 115a may receive the TB in a sub-PSSCH mapped to symbols within a sub-slot of a slot. In some aspects, a slot may be partitioned into multiple sub-slots that each include a set of symbols that carry a sub-PSSCH. Each sub-PSSCH may carry a TB.

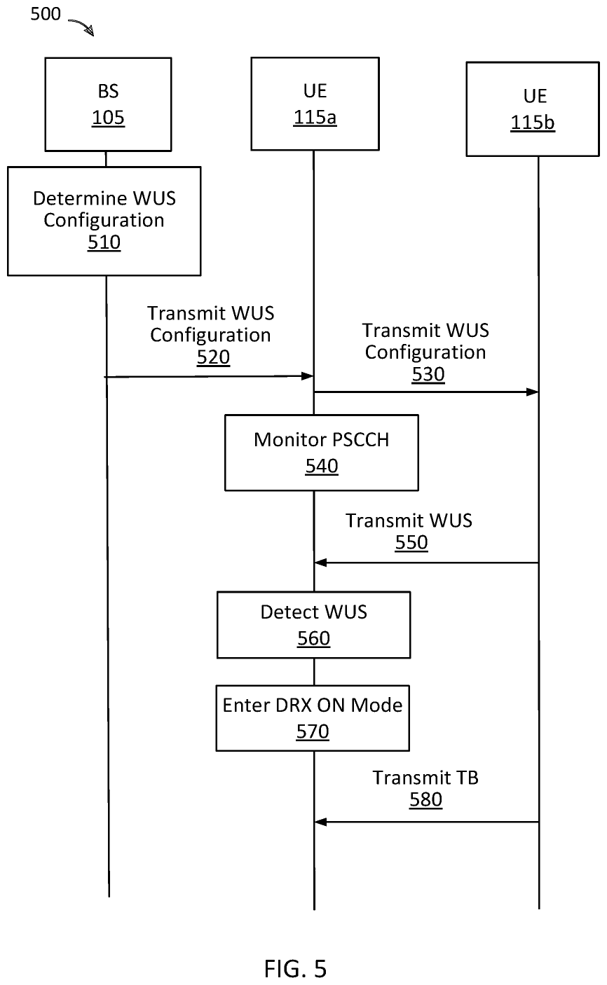

FIG. 5 is a signaling diagram of a communication method according to some aspects of the present disclosure. Aspects of the signaling diagram 500 can be executed by a computing device (e.g., a processor, processing circuit, and/or other suitable component) of a communication device or other suitable means for performing the aspects. For example, a communication device, such as the BS 105 or the BS 700, may utilize one or more components, such as a processor 702, a memory 704, instructions 706, a WUS detection module 708, a transceiver 710, a modem 712, an RF unit 714, and one or more antennas 716 to execute the aspects of signaling diagram 500. A wireless communication device, such as the UE 115 or UE 600, may utilize one or more components, such as the processor 602, the memory 604, the WUS detection module 608, the transceiver 610, the modem 612, and the one or more antennas 616, to execute the aspects of signaling diagram 500.

At 510, a BS 105 may determine a WUS configuration. The WUS configuration may include, without limitation, a location of the resource elements that carry a PSCCH, an amount of the offset before the DRX ON period, a number of DRX cycles, one or more resource pools (RP), a UE group identification, and/or a UE identification. The WUS configuration may include a location of the resource elements that include the PSCCH. For example, the WUS configuration may indicate the time resources (e.g., symbols, sub-slots, slots, subframes, etc.) in which the PSCCH is located. The WUS configuration may indicate the frequency resources (e.g., a frequency, a range of frequencies, a subchannel(s), a BWP, a subframe(s), or a subband(s), etc.) in which the PSCCH is located.

At 520, the BS 105 may transmit the WUS configuration to the UE 115a. In this regard, the BS 105 may transmit the WUS configuration to the UE 115a via at least one of radio resource control (RRC) signaling, PDCCH signaling, or media access control (MAC) control element (CE) signaling. The WUS configuration may indicate resources the UE 115a may monitor for a PSCCH. The UE may monitor for an SCI-1 in the PSCCH. In some aspects, the WUS configuration may indicate the time offset before the DRX ON period in which the UE will monitor for the monitor for an SCI-1 in the PSCCH. The time offset may include a time period or time duration before the beginning of the DRX ON period. The time offset may be indicated as a number of symbols, a number of sub-slots, and/or an amount of time (e.g., a number of microseconds, or milliseconds) before the beginning of the DRX ON mode. The offset may be based on the amount of time required for the UE to decode the SCI-1 in the PSCCH.

At 530, the UE 115a may transmit the WUS configuration to the UE 115b. The WUS may include the parameters required to wake up the UE 115a from a low power mode. The UE 115a may transmit the WUS configuration to the UE 115b so that the UE 115b may wake up the UE 115a when the UE 115b is scheduled to transmit a TB to the UE 115a.

At 540, the UE 115a may monitor resource elements for the PSCCH. The UE 115a may monitor for the PSCCH in resource elements configured by the WUS configuration. The UE 115a may monitor for the PSCCH transmitted by the UE 115b during an offset before the DRX ON period.

At 550, the UE 115b may transmit the WUS to the UE 115a. The UE 115a may receive the WUS from the UE 115b in a first subset of resources. In some aspects, the UE 115a may receive, from the UE 115b, the SCI-1 in a second subset of resources. The first subset of resources may be different from the second subset of resources. In this regard, the UE 115a may distinguish the WUS in the PSCCH from the SCI-1 based on the resources assigned to the SCI-1 in the PSCCH. For example, the BS 105 may assign certain time/frequency resources to the WUS and assign different time/frequency resources to the SCI-1 in the WUS configuration at 510.

At 560, the UE 115a may detect the WUS. The UE 115a may detect the WUS using any suitable method. For example, the UE 115a may detect the WUS in the PSCCH. In some aspects, the UE 115a may detect the WUS based on a cell radio network temporary identifier (C-RNTI) associated with the UE. The UE 115a may use the C-RNTI carried by the PSCCH to identify the UE 115a and differentiate the UE 115a from other UEs including the UE 115b. The C-RNTI may be a unique identification for the UE 115a used for identifying RRC connection and scheduling. The UE 115b may address the WUS individually to the UE 115a by including the C-RNTI in the WUS. The UE 115a may monitor the WUS for the C-RNTI that identifies the UE 115a and wake up from the low power mode to enter the DRX ON mode when the C-RNTI identifying the UE 115a is received.

In some aspects, the UE 115a may receive the WUS based on a group radio network temporary identifier (G-RNTI) carried by the PSSCH and associated with a group of UEs including the UE115a. The G-RNTI may identify a group of UEs and differentiate the group of UEs from other UEs or other groups of UEs. The G-RNTI may be a unique identification for the group of UEs used for identifying RRC connection and scheduling. The UE 115b may address the WUS to a group of UEs that includes the UE 115a by including the G-RNTI in the WUS. The UE 115a may monitor the WUS for the G-RNTI that identifies the group including the UE 115a and wake up from the low power mode to enter the DRX ON mode when the G-RNTI that includes the UE 115a is received.

In some aspects, the UE 115a may receive the WUS based on an amount of resources associated with receiving the SCI-1. In this regard, the amount of time/frequency resources associated with the SCI-1 may indicate the WUS. For example, an SCI-1 associated with x resources may indicate a WUS to the UE 115a while an SCI-1 associated with y resources may not indicate a WUS to the UE 115a. The amount of resources associated with the SCI-1 may include a number of symbols in the time domain. The amount of resources associated with the SCI-1 may include a number of resource elements, physical resource blocks, and/or number of subchannels in the frequency domain.

In some aspects, the UE 115a may receive the WUS based on a location of resource elements associated with the SCI-1. In this regard, the location of time/frequency resources associated with the SCI-1 may indicate the WUS. For example, an SCI-1 located at symbol index x may indicate a WUS to the UE 115a while an SCI-1 located at symbol index y may not indicate a WUS to the UE 115a. An SCI-1 located at frequency index x may indicate a WUS to the UE 115a while an SCI-1 located at frequency index y may not indicate a WUS to the UE 115a. The location of time resources associated with the SCI-1 may include a range of symbol locations. The location of frequency resources associated with the SCI-1 may include a range of locations of resource elements, physical resource blocks, and/or subchannels. In some aspects, the location of time/frequency resources associated with the SCI-1 may indicate a WUS for a group of UEs that includes the UE 115a. Each of the UEs in the group may monitor the location of resource elements associated with the SCI-1. If the UE 115a detects the SCI-1 in the location of the SCI-1 resources assigned to that group, the UEs may wake up from a low power mode and enter a DRX ON mode.

In some aspects, the UE 115a may receive the WUS based on receiving an SCI-1, decoding a UE identifier from the SCI-1, and matching the UE identifier in the SCI-1 with an identifier associated with the UE 115a. The UE 115a may receive the SCI-1 in the PSCCH. The UE identifier may be a unique identifier that differentiates the UE 115a from other UEs. In some aspects, each UE may have its own UE identifier to distinguish itself from other UEs. The UE 115a may decode the UE identifier in the SCI-1 and compare it to its own identifier. If the UE identifier in the SCI-1 matches the UE 115a identifier, the UE 115a may wake up from a low power mode and enter a DRX ON mode. In some aspects, decoding the UE identifier from the SCI-1 may include decoding a bitmap location (e.g., a specified field in the SCI-1 data structure) associated with the UE identifier in the SCI-1. The bitmap may be a data structure that associates a location in the SCI-1 to the UE identifier.

In some aspects, the UE 115a may receive the WUS based on receiving an SCI-1, decoding a group UE identifier from the SCI-1, and matching an identifier associated with the UE 115a to the group UE identifier. The UE 115a may receive the SCI-1 in the PSCCH. The group UE identifier may be a unique identifier that differentiates a group of UEs from another group of UEs. The UE 115a may decode the group UE identifier in the SCI-1 and compare it to its own group identifier. If the group UE identifier in the SCI-1 matches the UE 115a's group identifier, the UE 115a may wake up from a low power mode and enter a DRX ON mode. In some aspects, decoding the group UE identifier from the SCI-1 may include decoding a bitmap location (e.g., a specified field in the SCI-1 data structure) associated with the group UE identifier in the SCI-1. The bitmap may be a data structure that associates a location in the SCI-1 to the group UE identifier.

In some aspects, the offset from the DRX ON period may be based on the group UE identifier. The offset may be indicated as a number of symbols, a number of sub-slots, and/or an amount of time (e.g., a number of microseconds, or milliseconds) before the beginning of the DRX ON period. The offset may be based on the amount of time required for the UE 115a to decode the SCI-1. The offset from the start of the DRX ON period may be based on the UE group identifier indicated in a group identifier field in the SCI-1. The UE 115a may monitor for the WUS based on the offset associated with its UE group identifier. Each of the UEs in the same group (e.g., having the same group UE identifier) may monitor for the WUS based on the offset associated with its UE group identifier. The offset associated with each UE group identifier may be a different time period in which the UE group monitors for the WUS.

In some aspects, the WUS may include an indicator indicating a resource pool (RP) of a plurality of RPs assigned to the UE115a. Each RP may include the time/frequency resources to be used in sidelink communications. The UE 115a may be assigned a plurality of RPs from the BS 105 in the WUS configuration at 510. The plurality of RPs may be assigned in a configured grant (CG). In this regard, the UE 115a may receive the CG in an RRC message and/or a DCI message (e.g., a unicast DCI3 message and/or a groupcast DCI3 message) from the BS 105. The WUS may include an indicator indicating which of the assigned RPs the UE 115a may use after waking up from a low power mode and entering the DRX ON mode. For example, each assigned RP may be identified by an RP index. The WUS may be indicated in the SCI-1. A field in the SCI-1 may indicate the RP that the UE 115a may use during the DRX ON duration based on the RP index.

In some aspects, the WUS may indicate a number of DRX cycles (e.g., DRX cycles 218) associated with the WUS. Each DRX cycle may include a DRX ON period (e.g., DRX ON period 216) and a DRX OFF period (e.g., DRX OFF period 216). Each of the DRX ON period and the DRX OFF period may be configured by the BS 105 in an RRC message. The WUS may be indicated in the SCI-1. A field in the SCI-1 may indicate the number of DRX cycles associated with the WUS. For example, the UE 115a may receive a WUS during an offset (e.g., DRX ON offset 220) before the DRX ON period. The WUS may indicate that two DRX cycles (e.g., DRX cycle 218(1) and 218(2)) are associated with the WUS. Based on the indication, the UE 115a may enter the DRX ON mode followed by the DRX OFF mode for the two DRX cycles following the WUS.

At 570, the UE 115a may enter a DRX ON mode. The UE 115a may enter the DRX ON mode in response to receiving the WUS. The UE 115a may enter the DRX ON mode if the UE 115a receives the WUS during the offset period in which the UE 115a is monitoring for the SCI-1 in the PSCCH signal. The UE 115a may not enter the DRX ON mode (e.g. refrain from entering the DRX mode) if the UE 115a does not receive the WUS during the offset period in which the UE 115a is monitoring for the WUS. In some aspects, the UE 115a may power down a portion of its receiver to reduce power consumption when monitoring for the WUS during the offset period. If the UE 115a receives the WUS and enters the DRX ON mode, the UE 115a may power up the portion of its receiver that was powered down during the offset period and monitor for sidelink signals. In some aspects, the UE 115a may enter one or more DRX ON periods based on receiving the WUS. When the UE 115a is operating in the DRX ON mode for a DRX ON period, the UE 115a may monitor for sidelink communications from the UE 115b and/or transmit sidelink communications to other UEs. For example, when the UE 115a is operating in the DRX ON mode, the UE 115a may monitor for a physical sidelink control channel (PSCCH), a physical sidelink shared channel (PSSCH), a physical sidelink broadcast channel (PSBCH) communications, other types of sidelink communications, physical downlink control channel (PDCCH) communications, physical downlink shared channel (PDSCH) communications, and/or physical broadcast channel (PBCH) communications.

At 580, the UE 115b may transmit a TB to the UE 115a. The UE 115b may transmit a TB to the UE 115a via a PSSCH. The UE 115a may receive the TB from the UE 115b based on monitoring for sidelink communications from the UE 115b during the DRX ON period after receiving the WUS. The UE 115a may receive the TB in resources configured by a configured grant (CG). For example, the UE 115a may receive a CG from the BS 105 and/or the UE 115b that configures time/frequency resource for the UE 115a to receive sidelink communications and/or transmit sidelink communications. In some aspects, the UE 115a may receive the TB in a PSSCH mapped to symbols within a slot. Additionally or alternatively, the UE 115a may receive the TB in a sub-PSSCH mapped to symbols within a sub-slot of a slot. In some aspects, a slot may be partitioned into multiple sub-slots that each include a set of symbols that carry a sub-PSSCH. Each sub-PSSCHs may carry a TB.

Aspects of the present disclosure may provide a wakeup signal (WUS) that may be received by the UE 115a during an offset time period before the DRX ON period. The WUS may inform the UE 115a if there is a TB or other communication scheduled for the UE 115a, enabling it to enter a DRX ON mode and monitor for receiving the TB or other communication. If the UE 115a does not detect a WUS, the UE 115a may return to a low power mode through the next DRX ON period. The WUS may be transmitted to the UE 115a by the UE 115b only when there is data to be communicated to the UE 115a thus saving power by allowing the UE 115a to stay in a low power mode when there is no data to be communicated to the UE 115a. In some aspects, the UE 115a may monitor the communication channel for an SCI-1 in a PSCCH that indicates the UE 115a should enter the DRX ON mode. The PSCCH may include an indicator that there is data and/or control information to be communicated to the UE 115a. The UE 115a may place its receiver in a mode capable of receiving the data and/or control information in response to receiving the indicator.

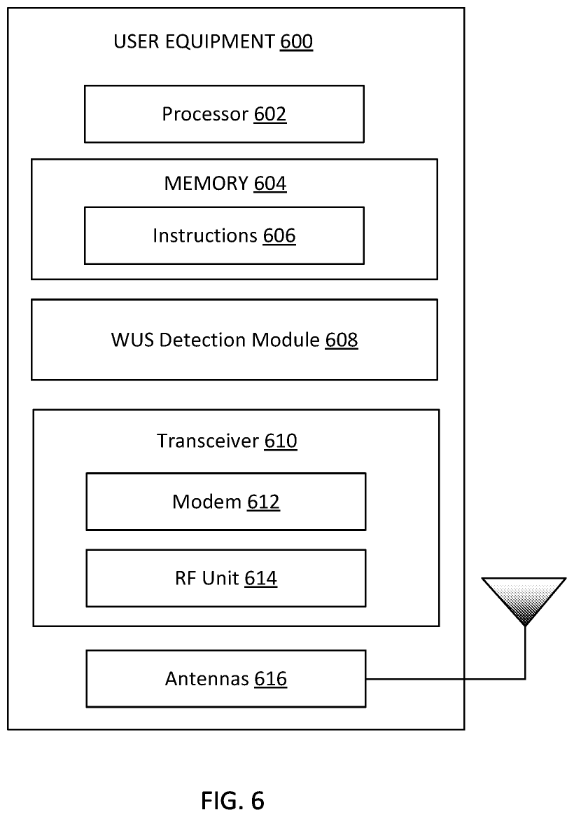

FIG. 6 is a block diagram of an exemplary UE 600 according to some aspects of the present disclosure. The UE 600 may be the UE 115 in the network 100 as discussed above. As shown, the UE 600 may include a processor 602, a memory 604, a WUS detection module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The WUS detection module 608 may be implemented via hardware, software, or combinations thereof. For example, the WUS detection module 608 may be implemented as a processor, circuit, and/or instructions 606 stored in the memory 604 and executed by the processor 602.

The WUS detection module 608 may be used for various aspects of the present disclosure, for example, aspects of FIGS. 2-5 and 8-9. The WUS detection module 608 is configured to enable a wakeup signal (WUS) that may be received by the UE 600 during an offset time period before the DRX ON period. The WUS may inform the UE 600 if there is a TB or other communication scheduled for the UE 600, enabling it to enter a DRX ON mode and monitor for receiving the TB or other communication. If the UE 600 does not detect a WUS, the UE 600 may return to a low power mode through the next DRX ON period. The WUS may be transmitted to the UE 600 by another UE only when there is data to be communicated to the UE 600 thus saving power by allowing the UE 600 to stay in a low power mode when there is no data to be communicated to the UE 600.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the WUS detection module 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages such as the WUS for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

In some aspects, the processor 602 may be coupled to the memory 604, the WUS detection module 608, and/or the transceiver 610. The processor 602 and may execute operating system (OS) code stored in the memory 604 in order to control and/or coordinate operations of the WUS detection module 608 and/or the transceiver 610. In some aspects, the processor 602 may be implemented as part of the WUS detection module 608.

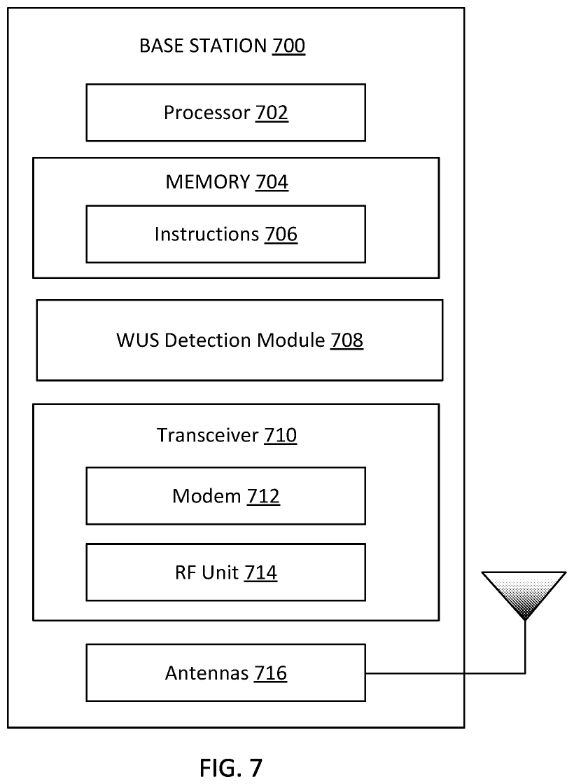

FIG. 7 is a block diagram of an exemplary BS 700 according to some aspects of the present disclosure. The BS 700 may be a BS 105 as discussed above. As shown, the BS 700 may include a processor 702, a memory 704, a WUS detection module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The WUS detection module 708 may be implemented via hardware, software, or combinations thereof. For example, the WUS detection module 708 may be implemented as a processor, circuit, and/or instructions 706 stored in the memory 704 and executed by the processor 702.

The WUS detection module 708 may be used for various aspects of the present disclosure, for example, aspects of FIGS. 2-5 and 8-9. The WUS detection module 708 is configured to transmit, to a UE (e.g., the UE 115, the UE 600), a configuration indicating WUS parameters that defines the parameters for the UE 115 or UE 600 to wake up from a low power state during an offset time before a DRX ON period. The WUS may inform the UE 600 if there is a TB or other communication scheduled for the UE 600, enabling it to enter a DRX ON mode and monitor for receiving the TB or other communication. If the UE 600 does not detect a WUS, the UE 600 may return to a low power mode through the next DRX ON period. The WUS may be transmitted to the UE 600 by another UE only when there is data to be communicated to the UE 600 thus saving power by allowing the UE 600 to stay in a low power mode when there is no data to be communicated to the UE 600.

Additionally or alternatively, the WUS detection module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 800. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 700 to enable the BS 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a WUS configuration according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the BS 700 can include multiple transceivers 710 implementing different RATs (e.g., NR and LTE). In some instances, the BS 700 can include a single transceiver 710 implementing multiple RATs (e.g., NR and LTE). In some instances, the transceiver 710 can include various components, where different combinations of components can implement RATs.

In some aspects, the processor 702 may be coupled to the memory 704, the WUS detection module 708, and/or the transceiver 710. The processor 702 may execute OS code stored in the memory 704 to control and/or coordinate operations of the WUS detection module 708, and/or the transceiver 710. In some aspects, the processor 702 may be implemented as part of the WUS detection module 708. In some aspects, the processor 702 is configured to transmit via the transceiver 710, to a UE, a WUS configuration.

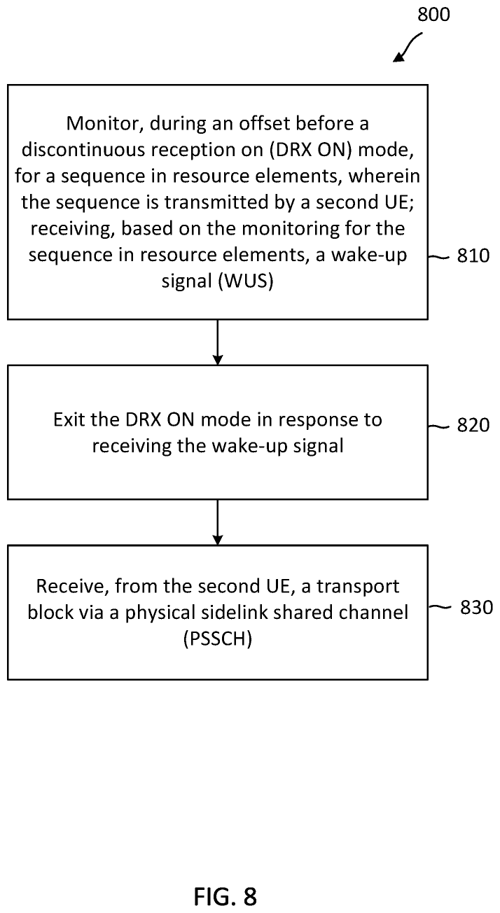

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the aspects. For example, a wireless communication device, such as the UE 115 or UE 600, may utilize one or more components, such as the processor 602, the memory 604, the WUS detection module 608, the transceiver 610, the modem 612, and the one or more antennas 616, to execute aspects of method 800. The method 800 may employ similar mechanisms as in the networks 100 and 200 and the aspects and actions described with respect to FIGS. 2-5. As illustrated, the method 800 includes a number of enumerated aspects, but the method 800 may include additional aspects before, after, and in between the enumerated aspects. In some aspects, one or more of the enumerated aspects may be omitted or performed in a different order.

At 810, the method 800 includes a UE (e.g., the UE 115 or the UE 600) monitoring, during an offset before a discontinuous reception on (DRX ON) period, for a sequence in resource elements transmitted by a second UE. The sequence may include any suitable type of sequence. For example, the sequence may include a pseudo-random sequence having a constant amplitude. The sequence may include, without limitation, a Zadoff-Chu sequence, an m-sequence, a Gold sequence, a Kasami sequence, a Barker sequence, a pseudo-random sequence, and/or combinations thereof. In some aspects, the sequence may be a sequence that is specific to the UE and/or a group of UEs that includes the UE. The wireless network (e.g., a BS in the wireless network) may assign a different sequence to one or more of the UEs such that each UE or each group of UEs may be individually woken up from a low power mode by the specific WUS sequence associated with the UE or group of UEs.

In some aspects, the sequence may include a scrambling code. The scrambling code may be any suitable type of scrambling code. A different scrambling code may be assigned to one or more UEs in the network. The UE may monitor the sequence to detect the scrambling code. When the assigned scrambling code is detected in the sequence during the offset, the UE may wake up from the low power mode and enter the DRX ON mode.

In some aspects, the UE may monitor a communication channel for a WUS that indicates the UE should exit the low power mode. For example, the UE may monitor for a physical sidelink control channel (PSCCH), an SCI-1, a physical sidelink shared channel (PSSCH), a physical sidelink broadcast channel (PSBCH) communications, other types of sidelink communications, physical downlink control channel (PDCCH) communications, physical downlink shared channel (PDSCH) communications, and/or physical broadcast channel (PBCH) communications. The WUS may be a sequence indicating that there is data and/or control information to be communicated to the UE. The UE may place its receiver in a mode capable of monitoring for and/or receiving the data and/or control information in response to receiving the WUS.

In some aspects, the UE may be configured to receive the WUS by receiving a WUS configuration from a BS (e.g., the BS 105 or the BS 700). The WUS configuration may include, without limitation, a location of the resource elements that carry the sequence, an amount of the offset before the DRX ON period, and/or a type of the sequence. In some aspects, the sequence may be transmitted in resource elements monitored by the UE. The resource elements may be indicated by the WUS configuration and include any time/frequency resources the UE is capable of monitoring. The resource elements may be resources reserved for (e.g., dedicated to) the UE. The reserved resources may be specific to the UE and other resources may be reserved for other UEs such that specific UEs may be woken from a low power mode based on the sequence being transmitted in the reserved resources specific to that UE. For example, the resources may be time domain resources that include certain symbols, slots, or sub-slots reserved for the UE. The resources may be frequency domain resources that include a certain frequency, range of frequencies, subchannel, or subbands reserved for the UE.

In some aspects, the resources may be resources reserved for (e.g., dedicated to) a group of UEs. The reserved resources may be specific to a group of UEs and other resources may be reserved for other groups of UEs such that specific groups of UEs may be woken from a low power mode based on the sequence being transmitted in the reserved resources specific to the UE group. For example, the resources may be time domain resources that include certain symbols, slots, or sub-slots reserved for the group of UEs. The resources may be frequency domain resources that include a certain frequency, range of frequencies, subchannel, BWP, or subbands reserved for the group of UEs.

The UE may monitor the resources during an offset before the UE is scheduled to enter the DRX ON mode. The offset may be a time period before the start of the DRX ON mode. The UE may monitor the resources from the beginning of the offset time period to the end of the offset time period. The end of the offset time period may be the beginning of the DRX ON period. The time offset may be indicated as a number of symbols, a number of sub-slots, and/or an amount of time (e.g., a number of microseconds, or milliseconds) before the beginning of the DRX ON mode. The offset may be based on the amount of time required for the UE to decode the WUS. In some aspects, the offset time period may occur before the DRX ON period but the DRX ON period may not immediately follow the offset time period. For example, there may be a time gap between the end of the offset period and the beginning of the DRX ON period. The UE may receive a configuration from a BS that includes the offset. In some aspects, the UE may transmit the WUS configuration to another UE (e.g., another sidelink UE). For example, a first UE may receive the WUS configuration from a BS. The WUS may include the parameters required to wake up the first UE from a low power mode. The first UE may transmit the WUS configuration to one or more other UEs that the first UE may communicate with. The first UE may transmit the WUS configuration to the one or more other UEs so that the one or more other UEs may wake up the first UE when they want to transmit to the first UE.

At 820, the method 800 includes a UE receiving, based on the monitoring for the sequence in resource elements, a wake-up signal (WUS) from another UE. In this regard, the UE may receive the WUS from another sidelink UE to facilitate receiving one or more TBs from the other UE. In some aspects, both the UE and the other UE may communicate over a sidelink channel (e.g., a PSCCH). The UE may have limited power source capacity and may benefit from operating in a low power mode when not communicating. The other UE may wake up the UE from the low power mode by transmitting a WUS to the UE and subsequently transmitting one or more TBs to the UE.

In some aspects, the UE may be configured to receive the WUS by receiving a WUS configuration from a BS (e.g., the BS 105 or the BS 700). The WUS configuration may include, without limitation, a location of the resource elements that carry the sequence, an amount of the offset before the DRX ON period, and/or a type of the sequence. In this regard, the UE may receive the WUS configuration from the BS via at least one of radio resource control (RRC) signaling, PDCCH signaling, or media access control (MAC) control element (CE) signaling. The WUS configuration may include a location of the resource elements that include the WUS sequence. For example, the WUS configuration may indicate the time resources (e.g., symbols, sub-slots, slots, subframes, etc.) in which the WUS sequence is located. The WUS configuration may indicate the frequency resources (e.g., a frequency, a range of frequencies, a subchannel(s), a BWP, a subframe(s), or a subband(s), etc.) in which the WUS sequence is located. The WUS configuration may indicate the resource elements are reserved for the WUS sequence.

In some aspects, the WUS configuration may indicate the time offset before the DRX ON period in which the UE will monitor for the WUS sequence. The time offset may include a time period or time duration before the beginning of the DRX ON period. The time offset may be indicated as a number of symbols, a number of sub-slots, and/or an amount of time (e.g., a number of microseconds, or milliseconds) before the beginning of the DRX ON mode. The offset may be based on the amount of time required for the UE to decode the WUS.

In some aspects, the WUS configuration may indicate the type of sequence used for the WUS. For example, the sequence may include a pseudo-random sequence having a constant amplitude. The sequence may include, without limitation, a Zadoff-Chu sequence, an m-sequence, a Gold sequence, a Kasami sequence, a Barker sequence, or a pseudo-random sequence. In some aspects, the WUS configuration may indicate a sequence that is specific to (e.g., assigned to) the UE. The WUS configuration may assign a unique sequence to the UE so that the UE may be individually woken up from a low power mode based on the UE receiving the specific sequence.

In some aspects, the UE may transmit the WUS configuration to another UE (e.g., another sidelink UE). For example, a first UE may receive the WUS configuration from a BS. The WUS may include the parameters required to wake up the first UE from a low power mode. The first UE may transmit the WUS configuration to one or more other UEs that the first UE may communicate with. The first UE may transmit the WUS configuration to the one or more other UEs so that the one or more other UEs may wake up the first UE when they want to transmit to the first UE.

In some instances, the UE may receive a wakeup signal (WUS) during the offset time period before the DRX ON period. In some aspects, the presence of the WUS may indicate to the UE that there is a transport block (TB) and/or other communication scheduled for the UE in the upcoming DRX ON period. If the UE detects a WUS in the offset time period before the DRX ON period, then the UE can enter the DRX ON mode and monitor for and/or receive the TB or other communication in the DRX ON period. If the UE does not detect a WUS in the offset time period before the DRX ON period, then the UE can immediately return to a low power mode or idle mode through the DRX ON period following the offset time period.

At 830, the method 800 includes a UE entering the DRX ON mode in response to receiving the wake-up signal. The UE may enter the DRX ON mode if the UE receives the WUS during the offset period in which the UE is monitoring for the WUS sequence. The UE may not enter the DRX ON mode (e.g. refrain from entering the DRX mode) if the UE does not receive the WUS during the offset period in which the UE is monitoring for the WUS sequence. In some aspects, the UE may power down a portion of its receiver to reduce power consumption when monitoring for the WUS sequence during the offset period. If the UE receives the WUS and enters the DRX ON mode, the UE may power up the portion of its receiver that was powered down during the offset period and monitor for sidelink signals. In some aspects, the UE may enter one or more DRX ON cycles based on receiving the WUS. When the UE is operating in the DRX ON mode for a DRX ON duration, the UE may monitor for sidelink communications from other UEs and/or transmit sidelink communications to other UEs. For example, when the UE is operating in the DRX ON mode, the UE may monitor for a physical sidelink control channel (PSCCH), a physical sidelink shared channel (PSSCH), a physical sidelink broadcast channel (PSBCH) communications, other types of sidelink communications, physical downlink control channel (PDCCH) communications, physical downlink shared channel (PDSCH) communications, and/or physical broadcast channel (PBCH) communications.

At 840, the method 800 includes the UE receiving, from the second UE, a transport block (TB) via a PSSCH. The UE may receive the TB from the second UE based on monitoring for sidelink communications from the second UE during the DRX ON duration. The UE may receive the TB in resources configured by a configured grant (CG). For example, the UE may receive a CG from a BS and/or another UE that configures time/frequency resource for the UE to receive sidelink communications and/or transmit sidelink communications. In some aspects, the UE may receive the TB in a PSSCH mapped to symbols within a slot. Additionally or alternatively, the UE may receive the TB in a sub-PSSCH mapped to symbols within a sub-slot of a slot. In some aspects, a slot may be partitioned into multiple sub-slots that each include a set of symbols that carry a sub-PSSCH. Each sub-PSSCH may carry a TB.

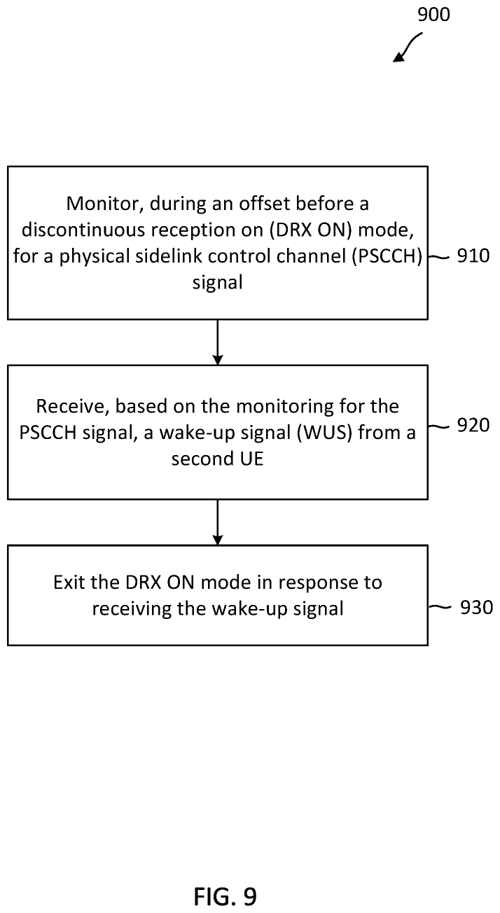

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the UE 115 or UE 600, may utilize one or more components, such as the processor 602, the memory 604, the WUS detection module 608, the transceiver 610, the modem 612, and the one or more antennas 616, to execute aspects of method 900. The method 900 may employ similar mechanisms as in the networks 100 and 200 and the aspects and actions described with respect to FIGS. 2-5. As illustrated, the method 900 includes a number of enumerated aspects, but the method 900 may include additional aspects before, after, and in between the enumerated aspects. In some aspects, one or more of the enumerated aspects may be omitted or performed in a different order.

At 910, the method 900 includes a UE (e.g., the UE 115 or the UE 600) monitoring, during an offset before a discontinuous reception on (DRX ON) period, for a physical sidelink control channel (PSCCH) signal. The UE may receive a WUS configuration that indicates the resources the UE may monitor for the PSCCH. The UE may monitor for an SCI-1 in the PSCCH. The UE may receive the WUS configuration from a BS (e.g., the BS 105 or the BS 700). The WUS configuration may include, without limitation, a location of the resource elements that carry the PSCCH, an amount of the offset before the DRX ON period, a number of DRX cycles, one or more resource pools, a UE group identification and/or a UE identification. In this regard, the UE may receive the WUS configuration from the BS via at least one of radio resource control (RRC) signaling, PDCCH signaling, or media access control (MAC) control element (CE) signaling. The WUS configuration may include a location of the resource elements that include the PSCCH. For example, the WUS configuration may indicate the time resources (e.g., symbols, sub-slots, slots, subframes, etc.) in which the PSCCH is located. The WUS configuration may indicate the frequency resources (e.g., a frequency, a range of frequencies, a subchannel(s), a BWP, a subframe(s), or a subband(s), etc.) in which the PSCCH is located.

At 920, the method 900 includes a UE receiving, based on the monitoring for the PSCCH signal, the WUS from a second UE. The UE may receive the WUS in a first subset of resources. In some aspects, the UE may receive, from the second UE, first stage sidelink control information (SCI-1) in a second subset of resources. The first subset of resources may be different from the second subset of resources. In this regard, the UE may distinguish the WUS in the PSCCH based on the resources assigned to the SCI-1 in the PSCCH. For example, a BS may assign certain time/frequency resources to the WUS and assign different time/frequency resources to the SCI-1. In this regard, the UE may receive the time/frequency resource assignments in an RRC message and/or a DCI message (e.g., a unicast DCI3 message and/or a groupcast DCI3 message) from the BS.

In some aspects, the UE may receive the WUS based on a cell radio network temporary identifier (C-RNTI) associated with the UE. The UE may use the C-RNTI to identify the UE and differentiate the UE from other UEs. The C-RNTI may be a unique identification for the UE used for identifying RRC connection and scheduling. The C-RNTI may be dedicated to a particular UE. The second UE may address the WUS individually to the UE by including the C-RNTI in the WUS. The UE may monitor the WUS for the C-RNTI that identifies the UE and wake up from the low power mode to enter the DRX ON mode when the C-RNTI identifying the UE is received.

In some aspects, the UE may receive the WUS based on a group radio network temporary identifier (G-RNTI) associated with a group of UEs including the UE. The UE may use the G-RNTI to identify a group of UEs and differentiate the group of UEs from other UEs or other groups of UEs. The G-RNTI may be a unique identification for the group of UEs used for identifying RRC connection and scheduling. The second UE may address the WUS to a group of UEs that includes the UE by including the G-RNTI in the WUS. The UE may monitor the WUS for the G-RNTI that identifies the group including the UE and wake up from the low power mode to enter the DRX ON mode when the G-RNTI that includes the UE is received.

In some aspects, the UE may receive the WUS based on an amount of resources associated with receiving the SCI-1. In this regard, the amount of time/frequency resources associated with the SCI-1 may indicate the WUS. For example, an SCI-1 associated with x resources may indicate a WUS to the UE while an SCI-1 associated with y resources may not indicate a WUS to the UE. The amount of resources associated with the SCI-1 may include a number of symbols in the time domain. The amount of resources associated with the SCI-1 may include a number of resource elements, physical resource blocks, and/or number of subchannels in the frequency domain.

In some aspects, the UE may receive the WUS based on a location of resource elements associated with the SCI-1. In this regard, the location of time/frequency resources associated with the SCI-1 may indicate the WUS. For example, an SCI-1 located at symbol index x may indicate a WUS to the UE while an SCI-1 located at symbol index y may not indicate a WUS to the UE. An SCI-1 located at frequency index x may indicate a WUS to the UE while an SCI-1 located at frequency index y may not indicate a WUS to the UE. The location of time resources associated with the SCI-1 may include a range of symbol locations. The location of frequency resources associated with the SCI-1 may include a range of locations of resource elements, physical resource blocks, and/or subchannels. In some aspects, the location of time/frequency resources associated with the SCI-1 may indicate a WUS for a group of UEs that includes the UE. Each of the UEs in the group may monitor the location of resource elements associated with the SCI-1. If the UE detects the SCI-1 in the location of the SCI-1 resources assigned to that group, the UEs may wake up from a low power mode and enter a DRX ON mode.

In some aspects, the UE may receive the WUS based on receiving an SCI-1, decoding a UE identifier from the SCI-1, and matching the UE identifier in the SCI-1 with an identifier associated with the UE. The UE may receive the SCI-1 in the PSCCH. The UE identifier may be a unique identifier that differentiates a UE from other UEs. In some aspects, each UE may have its own UE identifier to distinguish itself from other UEs. The UE may decode the UE identifier in the SCI-1 and compare it to its own identifier. If the UE identifier in the SCI-1 matches the UEs identifier, the UE may wake up from a low power mode and enter a DRX ON mode. In some aspects, decoding the UE identifier from the SCI-1 may include decoding a bitmap location (e.g., a specified field in the SCI-1 data structure) associated with the UE identifier in the SCI-1. The bitmap may be a data structure that associates a location in the SCI-1 to the UE identifier.

In some aspects, the UE may receive the WUS based on receiving an SCI-1, decoding a group UE identifier from the SCI-1, and matching an identifier associated with the UE to the group UE identifier. The UE may receive the SCI-1 in the PSCCH. The group UE identifier may be a unique identifier that differentiates a group of UEs from another group of UEs. The UE may decode the group UE identifier in the SCI-1 and compare it to its own group identifier. If the group UE identifier in the SCI-1 matches the UE's group identifier, the UE may wake up from a low power mode and enter a DRX ON mode. In some aspects, decoding the group UE identifier from the SCI-1 may include decoding a bitmap location (e.g., a specified field in the SCI-1 data structure) associated with the group UE identifier in the SCI-1. The bitmap may be a data structure that associates a location in the SCI-1 to the group UE identifier.

In some aspects, the offset from the DRX ON period may be based on the group UE identifier. The offset may be indicated as a number of symbols, a number of sub-slots, and/or an amount of time (e.g., a number of microseconds, or milliseconds) before the beginning of the DRX ON mode. The offset may be based on the amount of time required for the UE to decode the SCI-1. The offset from the start of the DRX ON period may be based on the group identifier indicated in a group identifier field in the SCI-1. The UE may monitor for the WUS based on the offset associated with its group identifier. Each of the UEs in the same group (e.g., having the same group UE identifier) may monitor for the WUS based on the offset associated with its group identifier. The offset associated with each group identifier may be a different time period in which the group monitors for the WUS.

In some aspects, the WUS may include an indicator indicating a resource pool (RP) of a plurality of RPs assigned to the UE. Each RP may include the time/frequency resources to be used in sidelink communications. The UE may be assigned a plurality of RPs from a BS. The plurality of RPs may be assigned in a configured grant (CG). In this regard, the UE may receive the CG in an RRC message and/or a DCI message (e.g., a unicast DCI3 message and/or a groupcast DCI3 message) from the BS. The WUS may include an indicator indicating which of the assigned RPs the UE may use after waking up from a low power mode and entering the DRX ON mode. For example, each assigned RP may be identified by an RP index. The WUS may be indicated in the SCI-1. A field in the SCI-1 may indicate the RP index that the UE may use during the DRX ON duration.

In some aspects, the WUS may indicate a number of DRX cycles associated with the WUS. Each DRX cycle may include a DRX ON period (e.g., a duration time) and a DRX inactivity duration time. Each of the DRX ON period and the DRX inactivity duration time may be configured by a BS in an RRC message. The WUS may be indicated in the SCI-1. A field in the SCI-1 may indicate the number of DRX cycles associated with the WUS. For example, the UE may receive a WUS during an offset before the DRX ON period. The WUS may indicate that two DRX cycles are associated with the WUS. Based on the indication, the UE may enter the DRX ON mode followed by the DRX inactive mode for the two DRX cycles following the WUS.

At 930, the method 900 includes a UE entering the DRX ON mode in response to receiving the WUS. The UE may enter the DRX ON mode if the UE receives the WUS during the offset period in which the UE is monitoring for the SCI-1 in the PSCCH signal. The UE may not enter the DRX ON mode (e.g. refrain from entering the DRX mode) if the UE does not receive the WUS during the offset period in which the UE is monitoring for the WUS in the SCI-1. In some aspects, the UE may power down a portion of its receiver to reduce power consumption when monitoring for the WUS during the offset period. If the UE receives the WUS and enters the DRX ON mode, the UE may power up the portion of its receiver that was powered down during the offset period and monitor for sidelink signals. In some aspects, the UE may enter one or more DRX ON periods based on receiving the WUS. When the UE is operating in the DRX ON mode for a DRX ON period, the UE may monitor for sidelink communications from other UEs and/or transmit sidelink communications to other UEs. For example, when the UE is operating in the DRX ON mode, the UE may monitor for a physical sidelink control channel (PSCCH), a physical sidelink shared channel (PSSCH), a physical sidelink broadcast channel (PSBCH) communications, other types of sidelink communications, physical downlink control channel (PDCCH) communications, physical downlink shared channel (PDSCH) communications, and/or physical broadcast channel (PBCH) communications.

In some aspects, the UE may receive, from the second UE, a TB via a PSSCH. The UE may receive the TB from the second UE based on monitoring for sidelink communications from the second UE during the DRX ON period after receiving a WUS. The UE may receive the TB in resources configured by a configured grant (CG). For example, the UE may receive a CG from a BS and/or another UE that configures time/frequency resource for the UE to receive sidelink communications and/or transmit sidelink communications. In some aspects, the UE may receive the TB in a PSSCH mapped to symbols within a slot. Additionally or alternatively, the UE may receive the TB in a sub-PSSCH mapped to symbols within a sub-slot of a slot. In some aspects, a slot may be partitioned into multiple sub-slots that each include a set of symbols that carry a sub-PSSCH. Each sub-PSSCH may carry a TB.

Aspects of the present disclosure may provide a wakeup signal (WUS) that may be received by the UE during an offset time period before the DRX ON period. The WUS may inform the UE if there is a TB or other communication scheduled for the UE, enabling it to enter a DRX ON mode and monitor for receiving the TB or other communication. If the UE does not detect a WUS, the UE may return to a low power mode through the next DRX ON period. The WUS may be transmitted to the UE by another UE only when there is data to be communicated to the UE thus saving power by allowing the UE to stay in a low power mode when there is no data to be communicated to the UE. In some aspects, the UE may monitor the communication channel for an SCI-1 in a PSCCH that indicates the UE should enter the DRX ON mode. The PSCCH may include an indicator that there is data and/or control information to be communicated to the UE. The UE may place its receiver in a mode capable of receiving the data and/or control information in response to receiving the indicator.

In some aspects, the PSCCH may include a demodulation reference signal (DMRS). The DMRS may be a reference signal used by the UE for channel estimation and/or compensating for Doppler effects. The DMRS may be included in at least one symbol of a slot. In this regard, the DMRS may be located anywhere within the slot. For example, the DMRS may be located in the first symbol of the slot, the last symbol of the slot, or an intermediate symbol of the slot. In some aspects, the DMRS may include all resource elements (REs) within the symbol. In some aspects, the DMRS may include a portion of the REs, but less than all of the REs within the symbol.

By way of non-limiting examples, the following aspects are included in the present disclosure.

Aspect 1 includes a method of wireless communication performed by a first user equipment (UE), the method comprising monitoring, during an offset before a discontinuous reception on (DRX ON) period, for a sequence in resource elements transmitted by a second UE; receiving, based on the monitoring for the sequence in resource elements, a wake-up signal (WUS) from the second UE; entering a DRX ON mode in response to receiving the wake-up signal; and receiving, from the second UE, a transport block via a physical sidelink shared channel (PSSCH).

Aspect 2 includes the method of aspect 1, further comprising receiving, from a base station (BS), a WUS configuration, wherein the WUS configuration comprises at least one of a location of the resource elements; an amount of the offset before the DRX ON period; or a type of the sequence.

Aspect 3 includes the method of any of aspects 1-2, wherein the receiving the WUS configuration includes receiving, by the first UE from the BS, the WUS configuration via at least one of radio resource control (RRC) signaling, PDCCH signaling, or media access control (MAC) control element (CE) signaling.

Aspect 4 includes the method of any of aspects 1-3, further comprising transmitting, to the second UE, a WUS configuration, wherein the WUS configuration comprises at least one of a location of the resource elements; an amount of the offset before the DRX ON period; or a type of the sequence.

Aspect 5 includes the method of any of aspects 1-4, wherein a type of the sequence comprises at least one of a Zadoff-Chu sequence; an m-sequence; a Gold sequence; a Kasami sequence; a Barker sequence; or a pseudo-random sequence.

Aspect 6 includes the method of any of aspects 1-5, wherein the resource elements are reserved for the first UE.

Aspect 7 includes the method of any of aspects 1-6, wherein the resource elements are reserved for a group of UEs, wherein the group of UEs includes the first UE.

Aspect 8 includes the method of any of aspects 1-7, wherein the sequence is associated with the first UE.

Aspect 9 includes the method of any of aspects 1-8, wherein the sequence comprises a scrambled code sequence associated with the first UE.

Aspect 10 includes a method of wireless communication performed by a first user equipment (UE), the method comprising monitoring, during an offset before a discontinuous reception on (DRX ON) period, for a physical sidelink control channel (PSCCH) signal; receiving, based on the monitoring for the PSCCH signal, a wake-up signal (WUS) from a second UE; and entering a DRX ON mode in response to receiving the wake-up signal.

Aspect 11 includes the method of aspect 10, wherein the receiving the WUS comprises receiving the WUS in a first subset of resources; and further comprising receiving, from the second UE, first stage sidelink control information (SCI-1) in a second subset of resources, wherein the first subset of resources is different from the second subset of resources.

Aspect 12 includes the method of any of aspects 10-11, wherein the receiving the WUS comprises receiving the WUS based on a cell radio network temporary identifier (C-RNTI) associated with the first UE.

Aspect 13 includes the method of any of aspects 10-12, the receiving the WUS comprises receiving the WUS based on a group radio network temporary identifier (G-RNTI) associated with a group of UEs including the first UE.

Aspect 14 includes the method of any of aspects 10-13, further comprising receiving first stage sidelink control information (SCI-1); and wherein the receiving the WUS comprises receiving the WUS based on an amount of resources associated with the SCI-1.

Aspect 15 includes the method of any of aspects 10-14, wherein the receiving the WUS comprises receiving the WUS based on a location of resource elements associated with first stage sidelink control information (SCI-1).

Aspect 16 includes the method of any of aspects 10-15, further comprising receiving first stage sidelink control information (SCI-1); and decoding a UE identifier from the SCI-1, wherein the receiving the WUS comprises receiving the WUS based on the UE identifier from the SCI-1 matching an identifier associated with the first UE.

Aspect 17 includes the method of any of aspects 10-16, wherein the decoding the UE identifier from the SCI-1 comprises decoding a bitmap location associated with the UE identifier in the SCI-1.

Aspect 18 includes the method of any of aspects 10-17, further comprising receiving first stage sidelink control information (SCI-1); and decoding a group UE identifier from the SCI-1, wherein the receiving the WUS comprises receiving the WUS based on the group UE identifier from the SCI-1 matching an identifier associated with a group of UEs including the first UE.

Aspect 19 includes the method of any of aspects 10-18, wherein the offset is based on the group UE identifier.

Aspect 20 includes the method of any of aspects 10-19, wherein the WUS includes at least one of an indicator indicating a resource pool (RP) of a plurality of RPs assigned to the first UE; or a number of DRX cycles associated with the WUS.

Aspect 21 includes a user equipment (UE) comprising a transceiver, a memory, and a processor coupled to the transceiver and the memory, the UE configured to perform any one of aspects 1-9.

Aspect 22 includes a user equipment (UE) comprising a transceiver, a memory, and a processor coupled to the transceiver and the memory, the UE configured to perform any one of aspects 10-20.

Aspect 23 includes a non-transitory computer-readable medium storing one or more instructions for wireless communication, the one or more instructions comprising one or more instructions that, when executed by one or more processors of a user equipment, cause the one or more processors to perform any one of aspects 1-9.

Aspect 24 includes a non-transitory computer-readable medium storing one or more instructions for wireless communication, the one or more instructions comprising one or more instructions that, when executed by one or more processors of a user equipment, cause the one or more processors to perform any one of aspects 10-20.

Aspect 25 includes a user equipment (UE) comprising one or more means to perform any one or more of aspects 1-9.

Aspect 26 includes a user equipment (UE) comprising one or more means to perform any one or more of aspects 10-20.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first user equipment (UE), the method comprising:
monitoring, during an offset before a discontinuous reception on (DRX ON) period, for a sequence in resource elements transmitted by a second UE;
receiving, based on the monitoring for the sequence in resource elements, a wake-up signal (WUS) from the second UE;
entering a DRX ON mode in response to receiving the wake-up signal; and
receiving, from the second UE, a transport block via a physical sidelink shared channel (PSSCH).

2. The method of claim 1, further comprising:
receiving, from a base station (BS), a WUS configuration, wherein the WUS configuration comprises at least one of:
a location of the resource elements;
an amount of the offset before the DRX ON period; or
a type of the sequence.

3. The method of claim 2, wherein the receiving the WUS configuration includes:
receiving, by the first UE from the BS, the WUS configuration via at least one of radio resource control (RRC) signaling, PDCCH signaling, or media access control (MAC) control element (CE) signaling.

4. The method of claim 1, further comprising:
transmitting, to the second UE, a WUS configuration, wherein the WUS configuration comprises at least one of:
a location of the resource elements;
an amount of the offset before the DRX ON period; or
a type of the sequence.

5. The method of claim 1, wherein a type of the sequence comprises at least one of:
a Zadoff-Chu sequence;
an m-sequence;
a Gold sequence;
a Kasami sequence;
a Barker sequence; or
a pseudo-random sequence.

6. The method of claim 1, wherein the resource elements are reserved for the first UE.

7. The method of claim 1, wherein the resource elements are reserved for a group of UEs, wherein the group of UEs includes the first UE.

8. The method of claim 1, wherein the sequence is associated with the first UE.

9. The method of claim 1, wherein the sequence comprises a scrambled code sequence associated with the first UE.

10. A method of wireless communication performed by a first user equipment (UE), the method comprising:
monitoring, during an offset before a discontinuous reception on (DRX ON) period, for a physical sidelink control channel (PSCCH) signal;
receiving, based on the monitoring for the PSCCH signal, a wake-up signal (WUS) from a second UE; and
entering a DRX ON mode in response to receiving the wake-up signal.

11. The method of claim 10, wherein:
the receiving the WUS comprises receiving the WUS in a first subset of resources; and
further comprising:
receiving, from the second UE, first stage sidelink control information (SCI-1) in a second subset of resources, wherein the first subset of resources is different from the second subset of resources.

12. The method of claim 10, wherein:
the receiving the WUS comprises receiving the WUS based on a cell radio network temporary identifier (C-RNTI) associated with the first UE.

13. The method of claim 10, wherein:
the receiving the WUS comprises receiving the WUS based on a group radio network temporary identifier (G-RNTI) associated with a group of UEs including the first UE.

14. The method of claim 10, further comprising:
receiving first stage sidelink control information (SCI-1); and
wherein the receiving the WUS comprises:
receiving the WUS based on an amount of resources associated with the SCI-1.

15. The method of claim 10, wherein:
the receiving the WUS comprises receiving the WUS based on a location of resource elements associated with first stage sidelink control information (SCI-1).

16. The method of claim 10, further comprising:
receiving first stage sidelink control information (SCI-1); and
decoding a UE identifier from the SCI-1, wherein the receiving the WUS comprises:
receiving the WUS based on the UE identifier from the SCI-1 matching an identifier associated with the first UE.

17. The method of claim 16, wherein:
the decoding the UE identifier from the SCI-1 comprises decoding a bitmap location associated with the UE identifier in the SCI-1.

18. The method of claim 10, further comprising:
receiving first stage sidelink control information (SCI-1); and
decoding a group UE identifier from the SCI-1, wherein the receiving the WUS comprises:
receiving the WUS based on the group UE identifier from the SCI-1 matching an identifier associated with a group of UEs including the first UE.

19. The method of claim 18, wherein:
the offset is based on the group UE identifier.

20. The method of claim 10, wherein the WUS includes at least one of:
an indicator indicating a resource pool (RP) of a plurality of RPs assigned to the first UE; or
a number of DRX cycles associated with the WUS.

21. A first user equipment (UE) comprising a transceiver, a memory, and a processor coupled to the transceiver and the memory, the first UE configured to:
monitor, during an offset before a discontinuous reception on (DRX ON) period, for a sequence in resource elements transmitted by a second UE;
receive, based on the monitoring for the sequence in resource elements, a wake-up signal (WUS) from the second UE;
enter a DRX ON mode in response to receiving the wake-up signal; and
receive, from the second UE, a transport block via a physical sidelink shared channel (PSSCH).

22. The first UE of claim 21, wherein the first UE is further configured to:
receive, from a base station (BS), a WUS configuration; and
transmit, to the second UE, the WUS configuration, wherein the WUS configuration comprises at least one of:
a location of the resource elements;
an amount of the offset before the DRX ON period; or
a type of the sequence.

23. The first UE of claim 21, wherein a type of the sequence comprises at least one of:
a Zadoff-Chu sequence;
an m-sequence;
a Gold sequence;
a Kasami sequence;
a Barker sequence; or
a pseudo-random sequence.

24. The first UE of claim 21, wherein the resource elements are reserved for at least one of:
the first UE; or
a group of UEs, wherein the group of UEs includes the first UE.

25. The first UE of claim 21, wherein the sequence comprises a scrambled code sequence associated with the first UE.

26. A first user equipment (UE) comprising a transceiver, a memory, and a processor coupled to the transceiver and the memory, the first UE configured to:
monitor, during an offset before a discontinuous reception on (DRX ON) period, for a physical sidelink control channel (PSCCH) signal;
receive, based on the monitoring for the PSCCH signal, a wake-up signal (WUS) from a second UE; and
enter a DRX ON mode in response to receiving the wake-up signal.

27. The first UE of claim 26, wherein the first UE is further configured to:
receive the WUS in a first subset of resources; and
receive, from the second UE, first stage sidelink control information (SCI-1) in a second subset of resources, wherein the first subset of resources is different from the second subset of resources.

28. The first UE of claim 26, wherein the first UE is further configured to:
receive the WUS based on at least one of:
a cell radio network temporary identifier (C-RNTI) associated with the first UE; or
a group radio network temporary identifier (G-RNTI) associated with a group of UEs including the first UE.

29. The first UE of claim 26, wherein the first UE is further configured to:
receive first stage sidelink control information (SCI-1), wherein:
the WUS is based on at least one of:
an amount of resources associated with the SCI-1; or
a location of resource elements associated with the SCI-1.

30. The first UE of claim 26, wherein the first UE is further configured to:
receive first stage sidelink control information (SCI-1); and
decode a UE identifier from the SCI-1, wherein:
the WUS is based on the UE identifier from the SCI-1 matching an identifier associated with the first UE.

31. The first UE of claim 26, wherein the WUS includes at least one of:
an indicator indicating a resource pool (RP) of a plurality of RPs assigned to the first UE; or
a number of DRX cycles associated with the WUS.
